(19) United States
(12) Patent Application Publication
(10) Pub. No.: US 2011/0248433 A1
(43) Pub. Date: Oct. 13, 2011

(54) Primary Spring

(76) Inventors: Anton Diemling, Lannach (AT); Markus Hubmann, Brodingberg (AT); Christian Madritsch, Graz (AT); Gerald Schobegger, Graz (AT); Florian Semrad, Graz (AT); Martin Teichmann, Graz (AT)

(21) Appl. No.: 13/140,605

(22) PCT Filed: Oct. 8, 2009
(86) PCT No.: PCT/EP2009/063068

§ 371 Date: Jun. 17, 2011

(30) Foreign Application Priority Data
Dec. 22, 2008 (AT) A1991/2008

(51) Int. Cl. B61F 5/30; F16F 1/40

(52) U.S. Cl. 267/3

(57) ABSTRACT

A primary spring for chassis of rail vehicles is provided. The spring is designed as a substantially rectangular layered spring that is fitted into a bearing housing.

### CROSS REFERENCE TO RELATED APPLICATIONS

This application is the US National Stage of International Application No. PCT/EP2009/063068 filed Oct. 8, 2009, and claims the benefit thereof. The International Application claims the benefits of Austrian Application No. A1991/2008 AT filed Dec. 22, 2008. All of the applications are incorporated by reference herein in their entirety.

### FIELD OF INVENTION

The invention relates to a primary spring for chassis of rail vehicles.

### BACKGROUND OF INVENTION

For chassis with axle-end bearings a plurality of spring solutions are known, such as cylindrical coil compression springs of steel, usually in combination with a rotationally symmetrical multi-layer spring based on natural rubber, conical layered springs, or shear-stressed layered springs. For chassis with inboard bearings the requirements for the springs are different. For example, there is a considerably greater stiffness requirement of 2000 to 5000 N/mm, in comparison with 800 to 2000 N/mm.

Known solutions with conical layered springs make poor use of the installation space and are not well integrated into the frame and bearing housing. Furthermore, such springs are difficult to design with a progression of the spring characteristic, which creates difficulties in solving the vehicle design conflicts between designing the roll characteristics and reducing the risk of derailing.

Through the transverse stiffness and the longitudinal stiffness these springs take on part of the wheel set guidance and must be taken into account when designing the wheel set guidance In the case of certain designs this can result in further constraints in implementing springs of this type.

### SUMMARY OF INVENTION

An object of the present invention is to provide a primary spring for chassis with inboard suspension that, while requiring the minimum of installation space (distance between center of spring and wheel disk) allows as much working space as possible for the spring action. This spring action is needed in particular for light vehicles with a high load capacity. The ratio of load to empty weight is a measure of the cost effectiveness of a vehicle.

The object is achieved with a spring of rectangular shape. The spring is a largely rectangular layered spring that fits the bearing housing.

This fitting provides two benefits: optimal force introduction into the bearing housing and an optimal low load on the elastomer layers by virtue of the kinematics of a link arm for the wheel set guidance.

The lateral and longitudinal stiffness of the spring is conceptually so low that taking into account, and therefore interactions with, the design of the wheel set guidance are not necessary.

For a more detailed representation of the invention 4 drawings are attached.

### BRIEF DESCRIPTION OF THE DRAWINGS

By way of example there are shown:

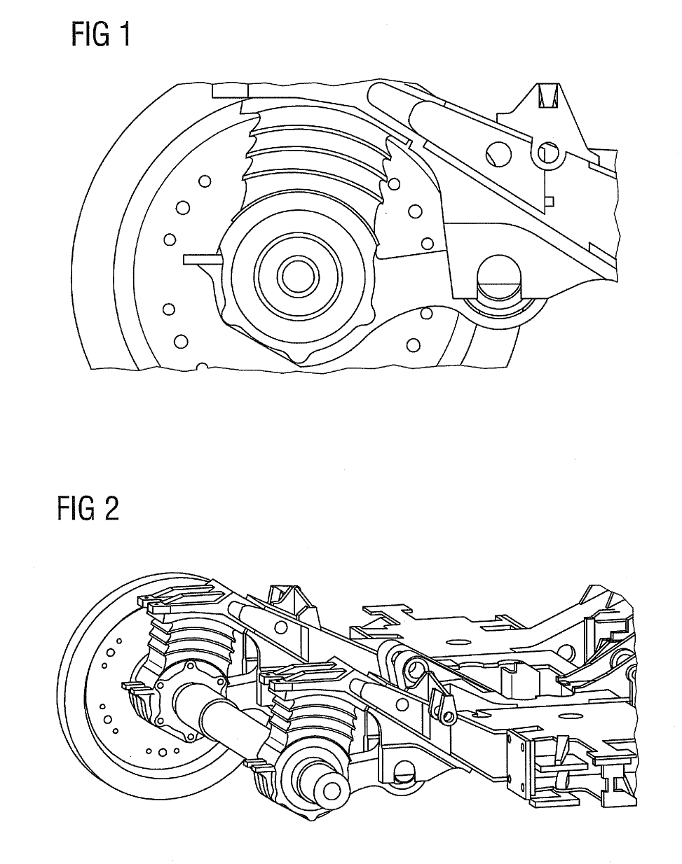

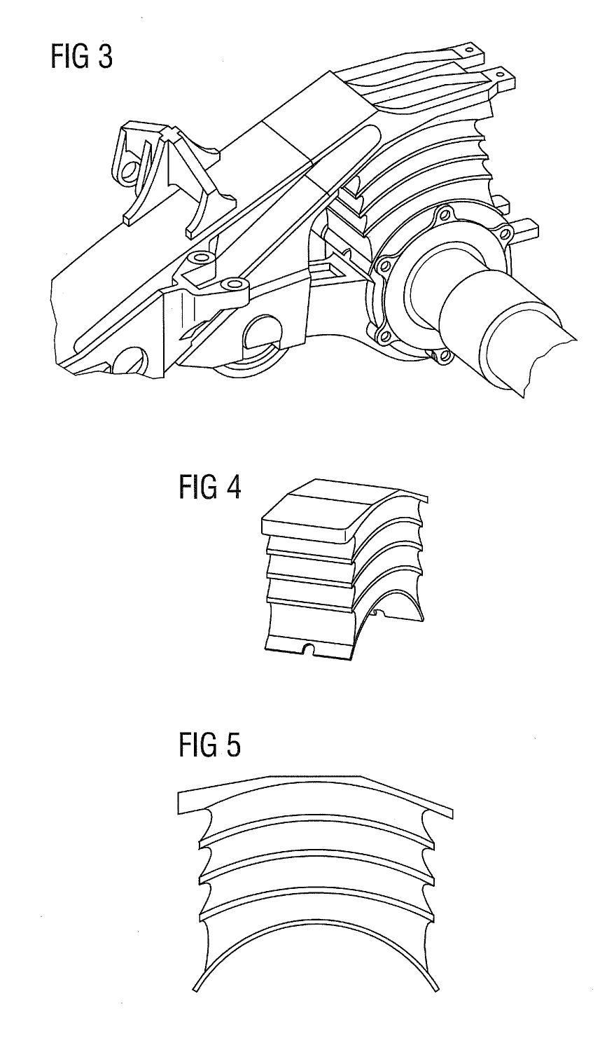

In FIGS. 1, 2 and 3, the configuration of a spring in accordance with the invention in a bearing housing of a wheel set guidance

In FIGS. 4 and 5, exemplary embodiments of the spring according to the invention.

1.-2. (canceled)

3. A primary spring for chassis of rail vehicles, wherein the spring is implemented as an essentially rectangular layered spring that is fitted into a bearing housing.

4. The primary spring as claimed in claim 3, wherein a transverse stiffness and a longitudinal stiffness of the spring are chosen to be so low such that there is no interaction with a design of a wheel set guidance.
